(19) United States
(12) Patent Application Publication
(10) Pub. No.: US 2008/0272607 A1
(43) Pub. Date: Nov. 6, 2008

(54) Dual release actuator assembly

(76) Inventors: John Trouy Kannapell, Torrance, CA (US); Benjamin Ming Lee, Lawndale, CA (US)

Correspondence Address: LOUIS L. DACHS, 1794 PALISADES DR., PACIFIC PALISADES, CA, 90272, US

(21) Appl. No.: 11/799,241

(22) Filed: May 1, 2007

(51) Int. Cl. E05C 3/16

(52) U.S. Cl. 292/216

(57) ABSTRACT

The invention is a dual release actuating assembly. In detail, the invention includes a link having first and second ends and a center section. A locking mechanism having a pin coupled to the center section of the is provided to prevent movement of the pin. An actuation rod is coupled to the second end of the link. A first actuator coupled to the first end of the link for moving the actuation rod in a first direction. A second actuator is coupled to the first end of the link for moving the actuation rod in a second direction. A unlocking system is includes to release the locking mechanism such that pin may translate allowing the link to rotate about the first end.

### GOVERNMENT INTEREST

This invention was made under United States Navy Contract N00019-02-C-3002, issued Oct. 26, 2001. Therefore, the United States Government has rights to the invention as specified in that contract.

### BACKGROUND OF THE INVENTION

1. Field of the Invention

The invention relates to the field of actuator assemblies for door locks and the like on aircraft and, in particular, to an actuator assembly that provides for back up actuation should the primary actuator fail.

2. Description of Related Art

Back up release systems for aircraft doors and landing gear are old in the art. Most multi-crew aircraft have manual systems. For example, a manual crank system for lowering the landing gear of old aircraft such as the B-17 aircraft. More modern multi-crew aircraft have manual release system that allows the landing gear to extend due to gravity. However on single seat aircraft, manual release system are generally avoided for the obvious reasons, some of which are: pilot effort required, space constraints for multiple manual release devices, such as pull-cables. The New fighter jet programs have increasingly more reliability requirements that require operation of critical aircraft systems even with severe damage. For example, on the US Marine version of the F-35 Aircraft, auxiliary engine inlet doors are positioned on the top of the fuselage between the vertical ducted fan and the engine. These doors must be opened during vertical landing. In this situation, the doors have hook/roller type locks that are actuated hydraulically. Although there is a primary and backup hydraulic system available for primary and emergency release, the prior art does not provide the ability to unlock if the primary actuator experiences a mechanical jam. Thus it is necessary to have a secondary release system so that the doors can be unlocked and actuated to the open position.

Thus, it is a primary object of the invention to provide a secondary release system for a door lock and the like.

It is another primary object of the invention to provide a secondary release system for a door lock that is compact.

It is a further object of the invention to provide a secondary release system for a door lock and the like wherein the door lock assembly is separate from the door actuator system.

### SUMMARY OF THE INVENTION

The invention is a dual release actuating assembly. In detail, the invention includes a link having first and second ends and a center section. A locking mechanism having a pin coupled to the center section of the link is provided to prevent movement of the pin. An actuation rod is coupled to the second end of the link. A first actuator is coupled to the first end of the link for moving the actuation rod in a first direction. A second actuator is coupled to the first end of the link for moving the actuation rod in a second direction. An unlocking system is includes to release the locking mechanism such that pin may translate allowing the link to rotate about the first end.

The locking assembly includes an over center latch mechanism coupled to the pin. This latch assembly includes a frame assembly having a channel with first and second ends. A block is slideably mounted in the channel and is adapted to receive the pin. An over center latch is mounted to the frame assembly to prevent movement of the block. An actuator is coupled to the over center latch for unlatching it. The over center latch mechanism further includes a biasing spring for causing the link to pivot about its first end thereof such that the link moves the output rod in the first direction.

The novel features which are believed to be characteristic of the invention, both as to its organization and method of operation, together with further objects and advantages thereof, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### BRIEF DESCRIPTION OF THE DRAWINGS

FIG. 1 is a plan view of an vertical take off and landing aircraft.

FIG. 2 is a side view of the auxiliary inlet door lock assemblies and subject dual release lock actuator assembly.

FIG. 3 is a side view of the subject dual release actuator assembly.

FIG. 4 is a cross-sectional view of FIG. 3 taken along the line 44.

FIG. 5 is a view similar to FIG. 3 with the emergency unlock system actuated.

### DESCRIPTION OF THE PREFERRED EMBODIMENT

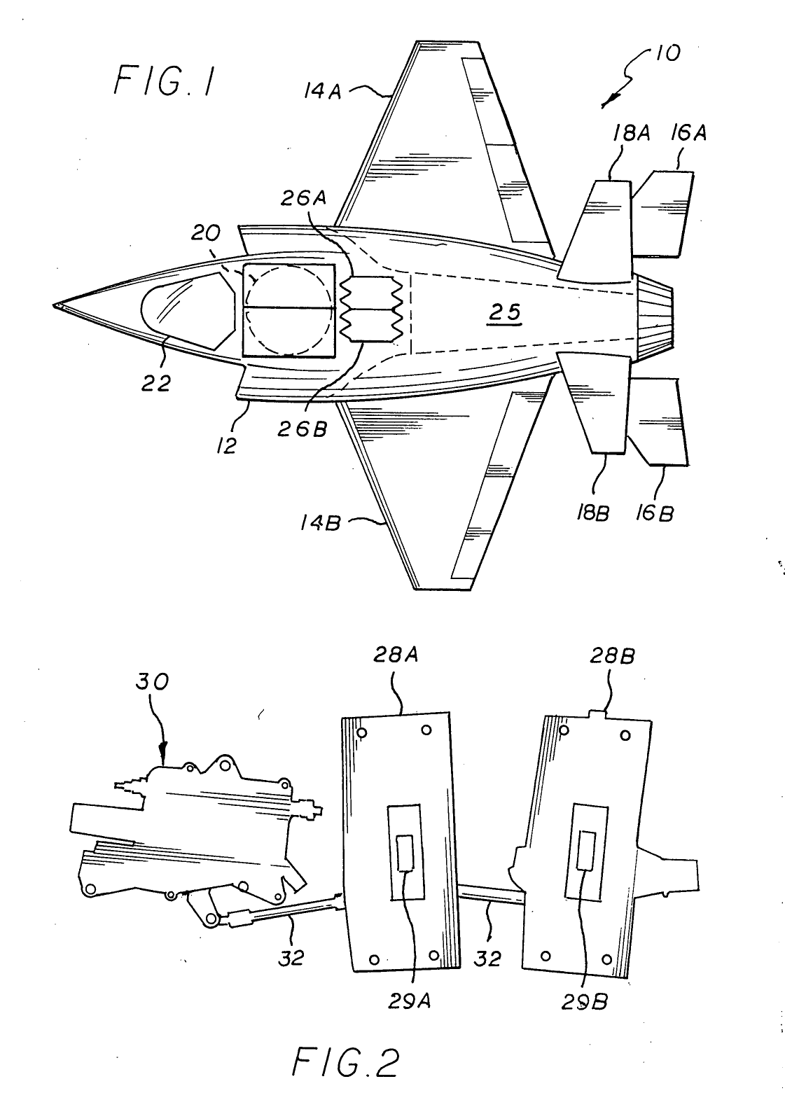

FIG. 1 is a plan view of a vertical takeoff and landing Marine version of the F-35 aircraft, generally indicated by numeral 10. This aircraft is provided for purposes of illustration only. The aircraft 10 includes a fuselage 12, wings 14A and 14B, elevators 16A and 16B and a rudders 18A and 18B. A lift fan 20 is positioned aft of the cockpit 22 between the lift fan 20 and propulsions system 25 shown in dotted lines are auxiliary air inlet doors 26A and 26B that must be opened to provide critical airflow to the engine when the aircraft is flying vertically. Referring to FIG. 2, the mechanical lock assemblies 28A and 28B, shown in outline only, are coupled to the doors 26A and 26B for the locking and unlocking the doors, by means of hooks 29A and 29B. The doors are locked in the closed position by a dual release actuator assembly 30 having an output rod 32 coupled to the both lock assemblies 28A and 28B. The lock assemblies 28A and 28B are not part of the invention, but are merely illustrated to show that the dual release actuator assembly locks and unlocks the hook/roller lock assemblies by pulling and pushing the rod 32.

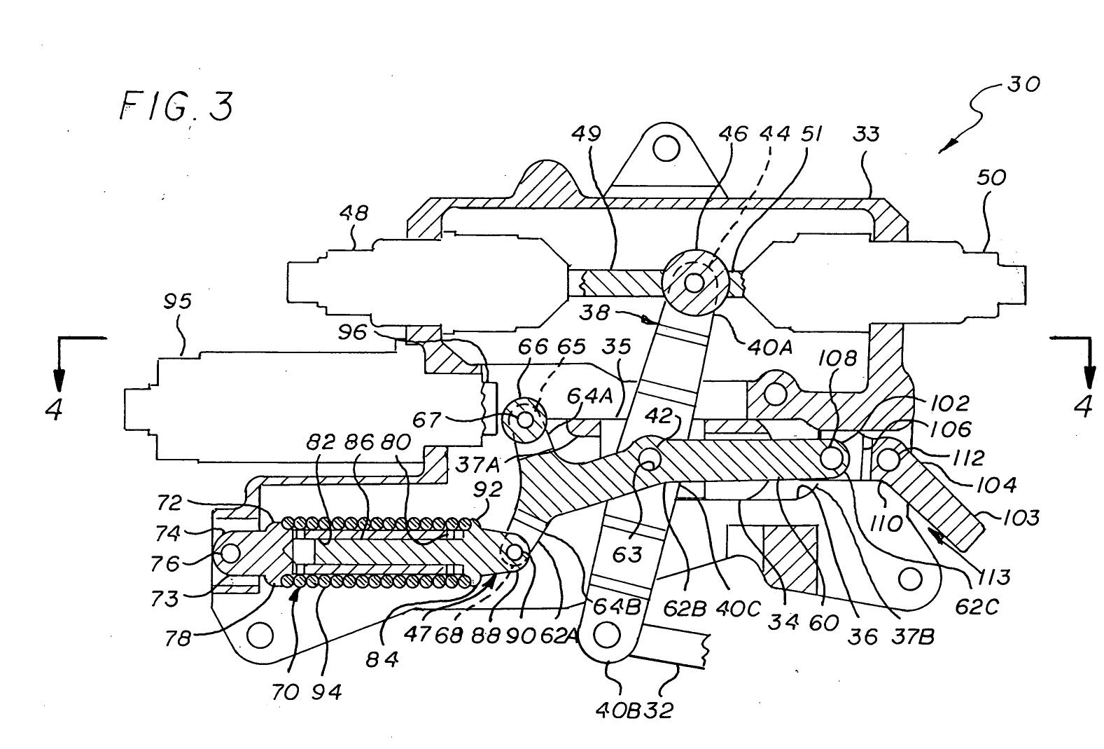

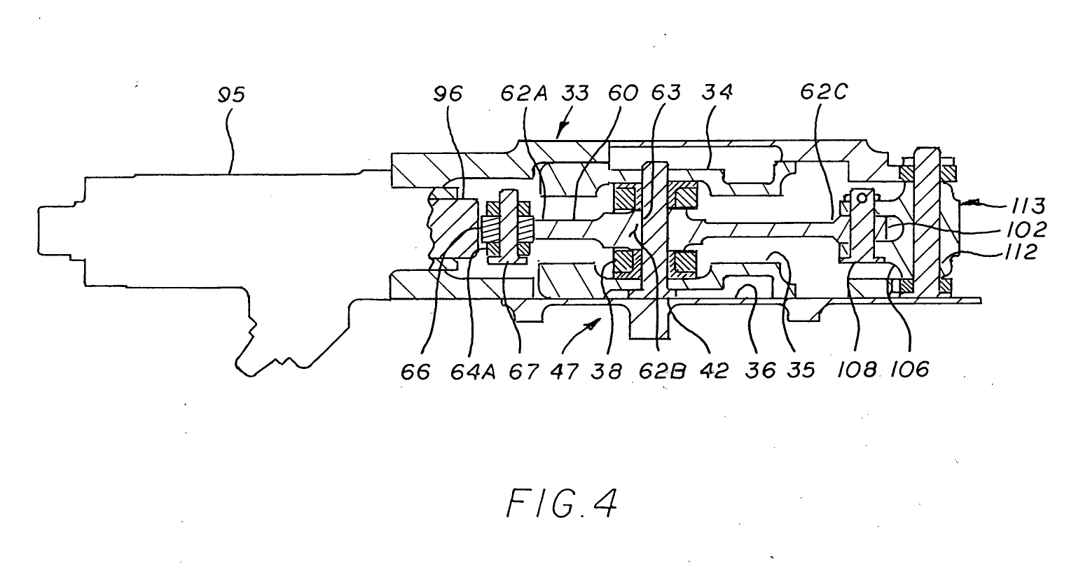

Referring to FIGS. 2-5, the dual release actuator assembly 30 includes a frame member 33. A block 34, having a passageway 35 therethrough, is slidably mounted in a channel 36 having first and second ends 37A and 37B. A link 38 includes first and second ends 40A and 40B and a middle portion 40C pined to the block 34 by pin 42 such that the link 38 can rotate about the pin. The end 40A terminates in a cleves 44 mounting a roller bearing 46. A locking system 47, which will be subsequently described, holds the block 34 in a stationary position within the channel 36.

A first actuator 48 is mounted in the frame member 33 and includes an output piston 49 in contact with roller bearing 46 on end 40A of the link 38 and is adapted to rotate the link 38 clockwise about the pin 42. A second actuator 50 is also mounted in the frame member 33 and includes an output piston 51 that also is in contact with bearing 46 on end 40A of the link 38 and is adapted to rotate the link counterclockwise about the pin 42. Thus as illustrated, rotation of the link 38 clockwise will cause the rod 32 to lock the door lock assemblies 28A and 28B and rotation of the link in a counterclockwise direction will cause the rod 32 to unlock the lock assemblies 28A and 28B. Typically, the actuators 48 and 50 are single direction types. That is, hydraulic fluid is only applied to one side the piston (not shown). In order for the link 38 to rotate about the pin 42, the block 34 must be restrained so it can not translate along the channel 36.

This is accomplished by the previously mentioned locking system 47, which will know be discussed in detail. The locking system 47 includes a link 60 having a forked first end 62A a middle section 62B and a second end 62C. The middle section 62B passes through passage way 35 of the block 34 and contains a hole 63, which has the pin 42 passing there through and thus rotates about the pin. The forked end 62A includes a leg 64A terminating in a clevis 65 having a roller 66 mounted therein by means of pin 67. The second end 62A includes a second leg 64B also terminating in a clevis 68.

A spring operated actuator assembly 70 includes a first member 72 having a first end 73 terminating in a lug 74 rotationally attached to the frame member 33 by means of pin 76. The first end 73 also includes a circular flange 78. The second end 80 of the member 72 is open and has a hole 82. A second member 84 includes a rod 86 that slidably engages hole 82 and further includes lug 88, which is attached to clevis 68 by means of pin assembly 90. The second member further includes a flange 92. A spring 94 mounted between the flanges 78 and 92 bias the link 60 to rotate counterclockwise about the pin 42. A hydraulic actuator 95 is mounted to the frame member 33 and has an output piston 96 in contact with the roller 66.

The second end 62C of the link 60 terminates in lug 102. A lever 1032 has a first end 104 terminating in a clevis 106 pivotally connected to the lever 102 by means of pin 108 and is also rotatably attached to the frame member 33 at intermediate point 110 by pin 112. The clevis 106 abuts the frame member 33 in the channel 36 wall in such a manner that clevis 106, lug 102 and link 103 operate as an over center latch 113 biased to this position by spring biased actuator 70. Thus the block 34 is prevented from moving. Therefore, the link 38 can only rotate about its middle portion 40C.

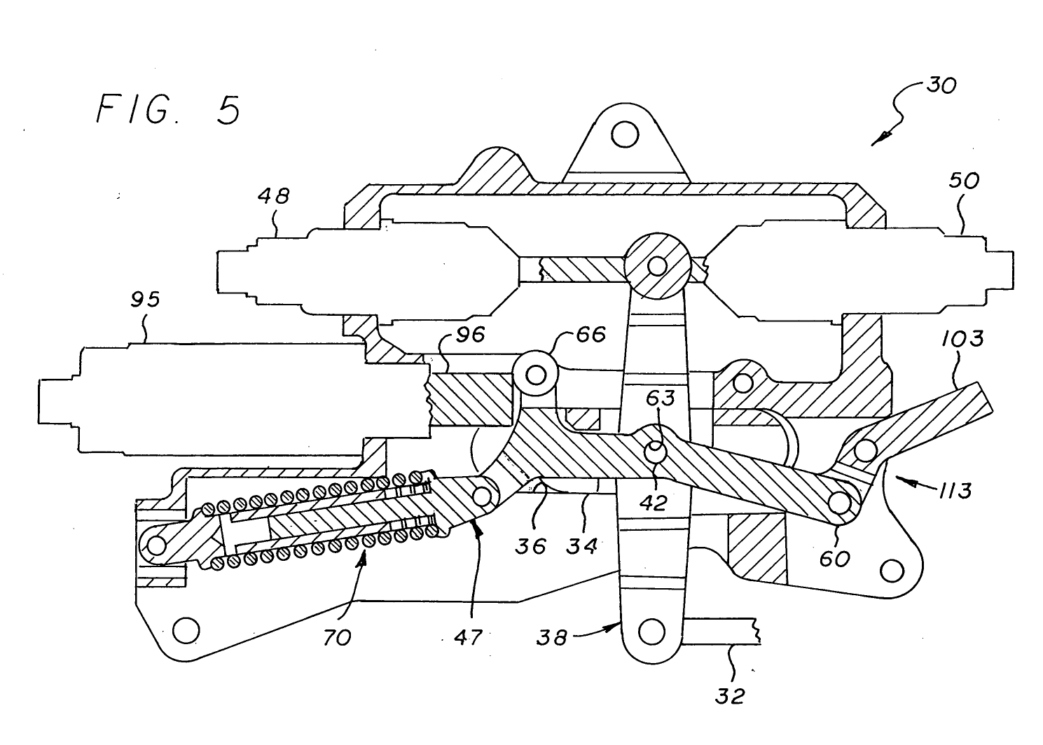

Particularly referring to FIG. 5, should actuators 48 or 50 freeze due to loss of hydraulic pressure, internal jam or battle damage, etc., then the hydraulic actuator 95 can be actuated, which will cause the output piston 96 to contact the roller 66 mounted on the link 60 causing the link 60 to rotate clockwise about the pin 38. This will cause the over center latch 113 to unlatch. This then allows the block 34 to translate in the channel 36, causing the link 38 to rotate about end 40A. This allows the rod 32 to unlock the hook mechanisms 28A and 28B. Note that the link 38 is free to translate vertically upward and downward so that the link 38 can rotate freely about end 40A. Furthermore, because the output shafts 49 and 51 only contact the end 40A, the link 38 is free to translate upward or downward as required. Resetting is simple; all that need be done is to rotate lever 102 clockwise.

While the invention has been described with reference to a particular embodiment, it should be understood that the embodiment is merely illustrative as there are numerous variations and modifications which may be made by those skilled in the art. Thus, the invention is to be construed as being limited only by the spirit and scope of the appended claims.

### INDUSTRIAL APPLICABILITY

The invention has applicability to the aircraft industry.

1. A dual release actuating assembly comprising:
a link having first and second ends and a center section;
a locking mechanism having a pin coupled to said center section of said link to prevent movement of said pin;
an actuation rod coupled to said second end of said link a first actuator coupled to said first end of said link for moving said actuation rod in a first direction;
a second actuator coupled to said first end of said link for moving said actuation rod in a second direction; and
means to release said locking mechanism such that pin may translate allowing said link to rotate about said first end.

2. The assembly as set forth in claim 1 where said locking mechanism includes an over center latch mechanism coupled to said pin.

3. The assembly as set forth in claim 2 wherein said over center latch mechanism comprises:
a housing having a channel having first and second ends;
a block slideably mounted in said channel, said block adapted to receive said pin; and
an over center latch mounted to said housing for preventing movement of said block; and
an actuator coupled to said over center latch for unlatching said over center latch.

4. The assembly as set forth in claim 3 wherein said over center latch mechanism further comprises a biasing means for causing said link to pivot about said first end thereof such that said link moves said output rod in said first direction.

5. The assembly as set forth in claim 4 wherein said biasing means is a spring.
